(19) United States
(12) Patent Application Publication
(10) Pub. No.: US 2023/0206181 A1
(43) Pub. Date: Jun. 29, 2023

(54) WORKFLOW SYSTEMS AND METHODS

(71) Applicant: SPEEDLANCER INC, San Francisco, CA (US)

(72) Inventor: Adam Stone, Caulfield Junction (AU)

(21) Appl. No.: 17/677,862

(22) Filed: Feb. 22, 2022

Related U.S. Application Data
(63) Continuation-in-part of application No. 16/131,604, filed on Sep. 14, 2018, now abandoned.
(60) Provisional application No. 62/558,403, filed on Sep. 14, 2017.

(51) Int. Cl. G06Q 10/10; G06Q 10/0631; G06Q 10/0639

(52) U.S. Cl. CPC G06Q 10/103; G06Q 10/063112; G06Q 10/06398

(57) ABSTRACT

A computer-based method and apparatus are provided for sourcing persons, organizations or computers capable of executing the tasks required to produce a product or an outcome, and for scheduling the requisite tasks. The computer-implemented method executes a desired workflow or provides a desired workflow deliverable. The method may include entering into workflow management software a desired workflow or desired workflow deliverable, the workflow management software then defines two or more requisite tasks, and a task executor for each of the tasks by reference to a database of task executors. A task executor may be a human or a computer. The workflow management software then directs the execution of the two or more requisite tasks by the task executor.

This application is a continuation-in-part of non-provisional patent application Ser. No. 16/131,604, filed on Sep. 14, 2018, which is of provisional patent application No. 62/558,403, filed on Sep. 9, 2014, and priority is claimed thereto.

### FIELD OF THE PRESENT INVENTION

The present invention relates to the field of computer systems configured to manage tasks required to produce a task product other outcome. In particular, the invention is directed to computer-based means for sourcing persons, organizations or computers capable of executing the tasks required to produce a product or an outcome, and for electronically scheduling the requisite tasks, aided by machine learning.

### BACKGROUND OF THE PRESENT INVENTION

Project management is typically labor intensive, requiring scoping, planning and budgeting followed by the selection of individuals capable of executing the tasks required to complete the project. Once a project team has been selected, each individual must be instructed as to what his/her task(s) within the project comprise. Once the project member teams are properly instructed tasks must be scheduled and commenced at the appropriate time. Intermediate task products are typically passed between individuals. Generally, a project manager is employed to oversee the overall project.

Some larger companies elect to retain staff required for ongoing and upcoming projects. This approach requires the company to recruit, train, pay and retain sometimes numerous staff. For example, a large bank may permanently employ an advertising team consisting of copywriters, graphic designers, webpage designers, and the like.

Other companies elect to outsource tasks to specialist individuals or organizations. Of course, this approach saves setup and ongoing staff costs however costs for each task product or outcome are typically higher compared with those of an in-house model.

For many smaller businesses, an in-house approach is not an option given the high costs of permanently employing staff, and also the possibility that tasks executable by those staff members may be sporadic. In small business or sole trader situations, the operator will often carry out the coordination of task himself or herself by liaising with as many providers as necessary so as to obtain the required product or outcome.

Thus, small and large business often rely on an outsourcing approach in achieving a task product or an outcome. As one example, a beverage company may wish to launch a new soda into the market. The project involves a number of tasks, with each task requiring certain skills. The new soda to be released by the beverage company will require a name (market research), a logo (graphic design), social media release (copywriting), and production of marketing collateral (printing, and novelty supplies). In an outsourcing model, the project manager must identify individuals or companies with all the required skills as listed above, consider quotations for fees, brief all parties involved, manage and check the work of each party, and make decisions along the way. As will be appreciated, these are all very labor-intensive tasks.

Quite apart from labor intensiveness, human error can occur in the execution of the project. These errors may lead to delays, cost overruns, or flawed task products or outcomes. Such errors may be minimized by the use of software packages such as Microsoft Project™ or Trello™ in the planning and execution stages of a project to allow for the allocation of required resources, schedule tasks, and track progress. While undoubtedly useful, such software packages have limitations and nevertheless require significant input and monitoring on the part of a project originator.

A technical problem in the art of computer-implemented workflow management is that the various parties involved are not in efficiently connected with a project originator (such as a project manager). The various parties may use different means of electronic communication, different file formats, different payment gateways, and the like, meaning that direct interaction between the parties is essentially prohibited. Thus, existing computerized work-flow management systems present technical problems in so far as computer technology is used to facilitate project task scheduling, project task execution, transmitting electronic work products and payments from party to party as required. If there were a way in which task allocation could be simplified and expedited while ensuring an effective means of communication in a standardized format remains employed, projects could be completed more efficiently. If there were a way in which project managers could effectively find and employ pertinent contractors for specific work in accordance with the proven track records, human error could be minimized as work performed would be completed by appropriate personnel.

Thus, there is a need for a more effective project management platform and system configured as an all-in-one solution which facilitates the selection of ideal candidates for tasks in accordance with their skill sets and availability while eliminating candidates which do not meet project requirements or goals. Preferably such a system is configured to automate portions (or all) of the project layout, including selection of contractors (task executors) based on criteria supplied by the project manager or project originator. Ideally, payments may also be automated based on milestones achieved. Similarly, automatic dispatching to freelancers could be instituted, and follow-ups could be automated to ensure completion of tasks. Such a system is preferably capable of automating full campaigns such as performing the role of a recruiter using software and contractors to achieve the goals of the project.

It is an aspect of the present invention to overcome or alleviate a problem with the prior art by provided improved workflow systems and methods. It is another aspect of the present invention to provide a useful alternative to the prior art.

The discussion of documents, acts, materials, devices, articles and the like are included in this specification solely for the purpose of providing a context for the present invention. It is not suggested or represented that any or all of these matters formed part of the prior art base or were common general knowledge in the field relevant to the present invention as it existed before the priority date of each provisional claim of this application.

### SUMMARY OF THE PRESENT INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

While various advantages are discussed throughout this specification, it is not represented that that all embodiments of the invention exhibit all advantages. Some embodiments may have only a single advantage, while some may have no advantage and provide merely an alternative to the prior art.

The present invention is predicated at least in part on Applicant's finding that advantage is gained where a computer-based system is provided which is capable of accepting as input project details from a user, and then identifying two or more parties (selected from individuals, companies or even computers) which are capable of executing the required tasks.

Accordingly, in a first aspect, the present invention provides a workflow management system comprising:

a workflow coordination computer comprising workflow management software and access to a database of human and/or computer task executors, wherein upon specification by a user of a desired workflow or a desired workflow deliverable, the workflow management software defines or allows to be defined, two or more requisite tasks, and interrogates the database of human and/or computer task executors to identify two or more task executors each capable of executing one of the two or more requisite tasks.

In some embodiments, the invention is directed to the production of a physical product, such as a business card, a printed novelty, a 3D printed object. The computer-implemented part(s) of the production may produce an electronic file (optionally stored on physical medium or transmitted in the form of a data signal) as an intermediate which is used to manufacture a physical product. For example, a word processor file may be used to generate a physical document, or a graphics file may be used to produce physical signage, or a 3D printing file or CAD file may be used to produce a physical three-dimensional product such as a toy or an engine part. The steps and/or hardware involved in the production of a physical product may be added to any computer-implemented method or computer system described herein.

In other embodiments, the product is not strictly physical but nevertheless real and of commercial value or some other value. Such embodiments include a product that is demonstrable on a processor-enabled device such as an image, an electronic text document, a video, music, or a sound. Another product of value produced according to the present invention may be software designed to perform some useful task or to provide a useful product (including a physical product) when executed by another computer.

Some embodiments of the invention allow for the various parties in a project team to use different means of electronic communication, different file formats, different payment gateways, and like to facilitate interaction between the parties. For example, converters may be provided (such as software means for converting a PDF file to an editable word processor document). Alternatively, the invention may compel the various parties to use predefined means of electronic communication, predefined file formats, predefined payment gateways, and like to facilitate interaction between the parties. For example, the uploading of certain file formats may be prohibited, with the offending party advised by a user interface to firstly convert the document to an acceptable format before uploading.

The present invention may allow for a user (such as a project originator) charged with the task of delivering a product or an outcome of some kind to be automatically provided with project team members, with each team member having a skill relevant to a required task of the project at hand. Thus, a project originator is assisted in identifying parties having the skills required to participate in the project. By this approach, a project originator may be presented (by a user interface of the system) the details of two or more potential task executors, thereby sparing the time and effort need to manually identify suitable executors denovo.

In describing the present invention, reference is often made to a project originator. As applied to an organization, the project originator may be a project manager or similar person seeking to execute a workflow on behalf of the organization. Alternatively, the project originator may be an individual seeking a product or an outcome for a personal reason, or for small business reasons.

As will be explained more fully throughout this specification, many embodiments of the invention are automated by software such that very little to no management of a project workflow is required once the workflow is initiated. The role of the project originator may be to simply define a desired product (which may be a physical product such as a business card), or to select several tasks from a series of predefined tasks in order for the workflow to operate. In that regard, it will be appreciated that the project originator is performing little to no management function may be consider simply as a “user”. Having stated that, some projects for which the present workflow systems and methods will be used will require that some judgement, selection, review or direction made is made by a project originator in the course of selecting task executors, approving fees, reviewing the task products of task executors, communicating with task executors, monitoring the progress of the workflow, and the like.

The database of task executors of the present invention may be provided as part of a platform dedicated to workflow planning and execution. In such circumstances the database may reside on a server owned, operated or administered by an entity dedicated to providing project management and execution series. Alternatively, the database may reside on a server owned, operated or administered by an entity which has as its primary function to aggregate and categorize a large number of individuals capable of acting as a task executor having the skills required to act as a task executor according to the present invention.

The database of the present system may be of any type capable of performing the functions described herein. Generally, the database is of the relational type, such as Advantage Database Server, Altibase, Apache Derby, Cubrid, Datacom, DB2, Drizzle, Empress Embedded Database, FileMaker, Firebird, HSQLDB, H2, Informix Dynamic Server, Ingres, InterBase, LucidDB, MAriaDB, MaxDB, Microsoft Access, FoxPro, Microsoft SQL Server, MonetDB/SQL, mSQL, Nexusdb, Omnis Studio, OpenLink Virtuoso, Oracle, Oracle, Rdb, Paradox, Peoplesoft, Pervasive PSQL, Polyhedra DBMS, Postgre SQL, RDM embedded, RDM server, SAP, ScimoreDB, smallSQL, SQL Anywhere, SQL Base, SQLite, Unidata and Xeround Cloud Database.

Any database of the invention may be embodied in the form of cloud server (which may be hosted by a third party, albeit with a security layer to ensure privacy). Certain system components, most of the components, or substantially all of the components (including servers, software, processors and the like) may be cloud-based. For example, the system may be configured at least in part in a “software as a service” format, or “platform as a service” format whereby participants in the system require only some computer-based means of engaging with the software or platform.

In some embodiments, the database may be embodied simply within a preference or settings function which identifies two or more task executors as stored within a user account of a project management platform. In this embodiment, the user populates the preference or settings function with two or more task executors. As will be appreciated, this embodiment will be suitable where a user wishes to select from a relative low number of task executors.

The database may include task executors that have actively joined the system with the aim of being retained by a project originator and receiving a fee for each task executed. Typically, a potential task executor is enabled by the system to generate a new task executor account. The user interface in this instance will typically require details such as username, password, name, address, email address, charging rate, and an indication of skills. The indication of skills will advantageously be entered by way of selection from a set list of skills (such as graphic design, research, branding etc.), with the option of entering free text. The interface may allow for the insertion of an image of the individual, as well as biographical information. From the information provided, an entry for the task executor is made on the system database. The task executor is then able to be located by a project originator using the platform to identify task executors for a project.

To maintain the integrity of the task executor database, a system administration entity may seek evidence of any skill, credential, certification, license, or work history from a task executor. Where such evidence is lacking, or a task executor performs poorly on designated tasks that task executor database entry may be deleted by the administrator.

The present invention may be considered as being capable of assembling a project team an automatically or semi-automatically, with each member of the team having one or more skills required for the execution of a complete project, or part of a project. The project team which is assembled by the system is based on a definition of workflows or the definition of a workflow deliverable (such as a product, product intermediate, or other outcome). As will be apparent from further description infra, many aspects of the project execution may take place automatically or at least with decreased input or action required by the project originator.

The workflow management software may automatically define the two or more requisite tasks, by being intrinsically programmed to do so when provided with a desired product or outcome. For example, the system may allow a project originator to define a desired product, such as a business card, and in which case the requisite tasks for the workflow are automatically generated by the software. In the case of a business card, the requisite tasks may be: (i) design logo (ii) design business card (iii) print business card. Alternatively, the project may define the requisite tasks by reference to a list of standard tasks provided by the software. As another alternative, the project originator may define a custom task. In any event, the requisite tasks are defined in some manner so as to allow the formation of a workflow.

The parties are termed task executors according to this first aspect (and other aspects) of the present invention. A task executor may be a human, and in some embodiments is a freelance worker having a defined skill. Freelance work is becoming more common across many industries, allowing for a company (or even an individual) to outsource tasks as required in order to complete a project. Many freelancers are available as task executors to a project originator, and the ability to review and select from a number of candidates decreases the originator's workload.

In some embodiments, the task executor is a group of individuals such as an organization, a partnership, a collective, a practice group or a company. The present system may treat such entities singularly for the purposes of identifying a task executor.

In other embodiments, the task executor is non-human and may be a computer which is programmed to execute a task, or a computer-controlled machine such as a printer or a computer-controlled lathe.

The system database may comprise details of a number of task executors for any given skill. For example, the database may comprise at least 5, 10, 20, 30, 40, 50, 60, 70, 80, 90, 100, 500, 1000, 5000 or 10000 graphic designers. Larger numbers of task executors make it more likely that a project originator will be able to identify an executor of sufficient experience, and furthermore available at the time required to perform the required task.

However, it is not necessary for the database to comprise a plurality, or even two task executors for each skill. In some embodiments only a single task executor is listed in respect of each skill, and the project originator has no choice but to use that task executor. A project originator may decide to only ever use a certain person to execute a certain type of tasks, and will therefore not wish to be presented with other executors having the same skill when constructing a workflow. In such embodiments, the advantage to the project originator is not in any decrease in the time and effort taken to identify a useful task executor (since only one is included on the database for the relevant skill), but instead the seamless integration of the task executor into the workflows that may be generated by the workflow management software.

In one embodiment of the first aspect, the workflow management software is configured to direct the execution of two of the two or more tasks in series. Where series execution of tasks is required (for example, graphic design for a brochure must be completed before brochure printing is commenced) the software will typically be configured such that in workflow the graphic design task is commenced first, and the final design approved by the project originator before the second task executor (the printer) is instructed by the software to commence printing.

In one embodiment of the first aspect, the workflow management software is configured to allow a task deliverable produced by a first human or computer task executor to be accessible by a second human or computer task executor. The project originator is therefore not required to forward an intermediate task product for a first task executor to a second task executor. In the prior art, the project originator may receive a completed logo from a graphic designer, and then send the logo (such as by way of email attachment) to a web designer for incorporation to a web page. The workflow management software may receive the logo as a graphics file by way of upload to a cloud server, and the software may then automatically generate an email having an embedded link to the web designer to allow the web designer to download the logo. In some embodiments, the web designer may have access to the various communications, instructions and uploads effected by parties earlier in workflow so as to provide a more complete understanding of the overall project.

As an alternative, both graphic designer and web designer may have permission to access files from a secure project-specific storage region of a cloud server. The logo is uploaded to the cloud server, and therefore becomes immediately accessible to the web designer who may then incorporate the logo into a web page. In some embodiments the software may provide a permissions function such that the web designer is not allowed to download the file until a project originator has approved the logo.

In one embodiment of the first aspect, the workflow management software is configured to direct the execution of two of the two of more tasks in parallel. A project may be expedited where task executors are instructed by the workflow management software to perform tasks related contemporaneously. For example, a web designer constructing a website, and a graphic designer generating a logo to be placed on the homepage of the website may perform their respective tasks contemporaneously. When both tasks are completed, the final webpage (with logo) is generated and published. In some embodiments, a task executor may have access to the various communications, instructions and uploads effected by parties earlier in workflow, and also effected by task executors working in parallel so as to provide a more complete understanding of the overall project.

A decision as to whether parallel execution of tasks is possible, or serial execution of tasks is mandatory may be made by the workflow management software-based software algorithmic means encoded in the workflow management software. For example, where a workflow comprises a printing task the algorithm may default to making that task the final task that is not commenced until all other tasks are completed. As another example, the algorithm may decide parallel execution for any tasks that are unrelated such as lodging an application for company registration and website design.

In one embodiment of the first aspect, the workflow management software is configured to allow a task deliverable to be accessible to a human project originator. In many instances input by a project originator will be desired or required, and in these circumstances the workflow (or some parts of the workflow) may be halted by the workflow management software until the relevant input is provided. One possible instance is where a graphic designer has generated three basic alternative logos for review by the project originator. The workflow management software may make the three designs accessible to the project originator, and further work on the logo design task is halted by the workflow management software (until the project originator selects one logo to be further developed). Once the selection is made, the workflow passes to the next task executor in line.

Accordingly, in one embodiment of the first aspect, the workflow management software is configured to request a decision by a human project originator before one or more tasks is/are commenced. The request may be generated by the workflow management software and present as a user interface on the project originator's “dashboard” for the project. The request may be for a decision (such as whether a proposed final logo design is acceptable—y/n?). In one embodiment of the first aspect, the decision is the selection of a preferred task deliverable from two or more alternative task deliverables (for example, the project originator is requested to click of a preferred logo from five options.

In one embodiment of the first aspect, the workflow management software is configured to allow a human project originator to associate a comment with a task deliverable, the comment being accessible by the task executor responsible for the task deliverable. This allows for a project originator to make nuanced comment on the deliverable for review by the executor. As one example of this embodiment, a proposed final logo is made accessible to the project originator, and a user interface provides a text box in which the manager seeks revision (e.g., “please change the grey areas of the logo to black”. Non-textual input may be made, with some embodiments of the system allowing for the project originator to draw (by touch screen or mouse) on the logo. In this way, the manager may indicate a sharp corner which should be rounded, or the position at which a further graphical component should be added.

In one embodiment of the first aspect, the workflow management software is configured to allow for duplex electronic communication between the human project originator and the human or computer task executor responsible for the task deliverable. This embodiment allows for a natural two-way communication between a human task executor and a project originator. A project originator who has suggested a revision to a logo may receive a text-based reply from the graphic designer providing a reason as to why the suggested revision is not appropriate. For example, where the manager suggests the introduction of fine details on a graphic, the designer may caution that a higher resolution image will be required, with this in turn resulting in slow loading of a website page displaying the graphic.

In one embodiment of the first aspect, the workflow management software is configured to (i) present a human user interface on a computer of a human task executor, and/or (ii) present a human user interface on a computer of a human task executor. As will be apparent from the above, each of the human task executors and the project originator will have a computer. Each computer will be in network communication such that the project originator can communicate electronically with each task executor (direct communications between two task executors may be prevented, unless specifically authorized by the project originator). In any event, each computer may be provided with means to display a human user interface. The interface may be generated remotely from the user's computer, and displayed on the computer (for example, where the interface is generated by a central server computer which serves the interface to the user (client) computer.

Conveniently, although not exclusively, the front end (user facing) interface of the system is implemented in the form of a web browser or similar contrivance. Such embodiments are preferred given the familiarity of browser interfaces to many individuals. Although browsers are primarily intended to use the World Wide Web, they can also be used to access information provided by web servers in private networks or files in file systems. The major web browsers are familiar to the skilled artisan, including Firefox™, Google™ Chrome™, Internet Explorer™, Opera™, and Safari™. In some embodiments, the user in facts interfaces with the present system via the Internet, and via a web browser.

In one embodiment, the system is configured such that each user logs into a central computer using credentials which causes the display of a dashboard-style interface on the user computer. The dashboard interface may be concerned with details of a single project only, and display messages from the project originator or other task executors participating in the project. In one embodiment of the first aspect, the human user interface is configured to display in human comprehensible form: information relating to a task, or a question relating to a task, or an option relating to a task. The information, question or option may be provided by way of text, graphic, video, synthesized speech, or recorded speech. An option may be presented by any of the foregoing means, or may be by way of providing a series or radio buttons or check boxes for completion by the user,

In one embodiment of the first aspect, the human user interface is configured to receive human generated input relating to a task, or a response relating to a task, or selection of an option relating to a task. The interface may be configured to receive input in the form of text, graphic, video, or speech.

In one embodiment of the first aspect, each of the two or more requisite tasks has one or more task parameters associated therewith. The function of a task parameter is to define the task so as to allow for the workflow management software to automate an action, or to provide input for any algorithm of the software to facilitate execution of the project.

In one embodiment of the first aspect, the one or more task parameters is/are specified by a human project originator or by the workflow management software. The workflow management software may allow the setting of parameters such as task executor skill. The task executor skill may be general (such as graphic design), moderate specificity (such as logo design) or high specificity (such as logo design for children's products). The task executable skill parameter is preferably directly matchable with a skill listed against a task executor in the system database. Accordingly, a set list of skills may be selected from when (i) entering the skills of a certain task executor on the system database, and (ii) when setting a task parameter. In this way, direct matches available. User-selected keywords may be used in place of or in addition to the set list of skills proposed, however it will be appreciated that because of the differential manner in which a skill may be described (e.g., “webpage design” versus “CSS, HTML”) the use of keywords alone is generally less preferred.

The task parameter may relate to task executor experience, such as the number of years practicing as a graphic designer, or the number of tasks completed via the present system (whether for the present project originator, or other project originators, or other entities)

The task parameter may be a task executor rating, as provided by other persons or entities (such as project originators) that have utilized the task executor previously. Conveniently, a star rating system (from zero stars to five stars) may be utilized.

Where a task executor has multiple skills, a dedicated for each skill may be provided in the task parameter on the database of the system. For critical tasks, the project originator may set a relatively high bar with respect to rating. For less critical tasks, a lower rating threshold may be set especially where the task has a low budget expenditure and very high caliber task executors may be simply too expensive.

In a more simple embodiment, a task may be routed to all task executors approved in a given category (e.g., ‘writers’), and each task executor is permitted by the system to selecting the tasks they feel most confident in being able to properly execute. It would be expected that a task executor will not accept a task that is beyond their capabilities, given the possibility of needing to execute multiple revisions, not receiving full payment, and receiving a poor rating from the task originator.

The task parameter may be a task executor price. A projector manager will typically have a budget and may wish to set a maximum price for a task. The price may be expressed as dollars per hour, or a unit price such as dollars per logo designed. As mentioned above, an interplay between rating and price may exist, such that the system allows for the project originator to filter task executors according to two parameters so as to identify the highest rating graphic designer that works at a rate of less than $100 per hour.

The task parameter may be set by the project originator, or may be set automatically by the workflow management software. In one embodiment, the task parameter may be task delivery time, or earliest task starting time. There will be little point in identifying a suitable task executor from the database if the identified executor is unable to complete the required task within a time restraint faced by the project originator. Again, there may an interplay between task executor rating and the availability of a task executor. Accordingly, more complex specification of task parameters may be used by a project originator in setting task parameters. For example, the project parameter may seek to identify a task executor of the highest rating that is able to complete the task within one week of a certain base date. The base date may be automatically imported into the task parameter based on a time restraint set by a task executor performing an earlier task upon which the present task is dependent. In this way, the task parameter functions as a means of greatly simplifying the process of identifying a task executor that is able to execute a task according to multiple variables (such as 2, 3, 4, 5, or 6 variables). In some instances, no task executor of the system database meets the required criteria and in such cases the project originator may be forced to relax ratings requirements, or increase the task budget for example.

As will be understood, the system database of task executors is typically dynamic, with details recorded against each executor changing according to alterations in ratings, availability, pricing and the like. Without the benefit of the present system, a project originator may be forced to make multiple enquiries of multiple task executors in order to find the combination of executors capable of forming a project team capable of delivering the product or outcome within limits of price, time and quality. Some embodiments of the present system allow for a project originator to perform complex, multifactorial searching and/or complex, multifactorial filtering of the task executor database so as to identify one or more appropriate task executor(s) for a given project.

A task parameter may be used to facilitate project management after the time that task executors are identified and retained for the project. In one embodiment, the task parameter is a project originator revision rule which may control whether an intermediate task product can progress from a first task executor to a second task executor only where a project originator (or indeed any other appointed party) approves the intermediate task product (being one type of task deliverable). As an example of the operation of such a task parameter, the workflow management software will not pass a logo to a webpage designer until the project originator has approved the logo. A task parameter may be embodied in the form of a “note” which is attached to a task, and visible on a user interface of the present system as viewed by a task executor. The note may include text, or a visual guide to assist comprehension. Task parameter may be dynamic, with a project originator being capable of altering or adding or deleting a task parameter in the course of a workflow. A task parameter may be computer readable or human readable.

A task parameter may define a required format for a task deliverable. The required format may be a file type (e.g., PDF, XML, JPEG, XLS, DOC), file configuration (e.g., one drawing per file, or all drawings in one file), file delivery (e.g. as email attachment, or saved onto a common cloud server), file size (e.g. less than 100 MB), and the like.

As discussed supra, a task executor may be selected on the basis of a rating provided by a person or entity that has experience of the task executor's work. In one embodiment of the first aspect, the workflow management software is configured to receive a rating of a human or computer task executor transmitted by a project originator, and to associate the rating with the human or computer executor on the system database. Accordingly, the present system may be configured to present a user interface on a user computer to allow the entry of a rating or a comment in relation to a task executor. Preferably the rating has a numerical basis so as to facilitate searching of the system database to identify a task executor having a rating, or a rating range, or a minimum rating. Typically, the interface will be presented to a project originator upon completion of a task by a task executor. In this way, an accurate assessment is more likely to be made, and while the project originator's experience with the task executor to be rated is front of mind.

In one embodiment of the first aspect, the workflow management system comprises a software interface configured to facilitate data import into the workflow management software from a computer of a human or computer task executor, or any other software. In another embodiment of the first aspect, the workflow management system comprises a software interface configured to facilitate data export from the workflow management software to the software of a computer human or computer, or any other software. For example, the system may comprise an application programming interface (API) which is capable of acting as a data/information exchange interface allowing data/information of one participant in the system to make use of data/information provided by another participant. By this embodiment, an electronic file created by application software of a first computer of a first task executor is usable by different application software of a second computer of a second task executor. Incompatibilities between computer operating systems, databases, spreadsheets, graphics documents, text document and the like are overcome thereby negating for the need for a project originator or a task executor to troubleshoot and incompatibilities

The tasks within a workflow may be defined by a project originator according to standardized workflow specification. Many users will be familiar with standardized workflow specifications such as Business Process Model and Notation (BPMN), Unified Modelling Language (UML), Life-cycle Modelling Language (LML), Subject-oriented business process management (S-BPM), Cognition enhanced Natural language Information Analysis Method (CogNIAM), Extended Business Modelling Language (xBML), Event-driven process chain (EPC), ICAM DEFinition (IDEFO), Formalized Administrative Notation (FAN), and Harbarian process modelling (HPM), or a functional equivalent thereof. Non-standard specifications will be clearly operable, however given that many users will already be familiar with standard specifications such embodiments are preferred. A simplified version of any of these specifications may be devised and used where deemed appropriate by the skilled person.

Generally, a graphical user interface is presented to the user to allow the user to position task icons in a desired order, and to connect task icons with each other so as to represent the movement of an intermediate task product from one task executor to another task executor. Task parameters (as described supra) may be associated with a task shown on the user interface. Text may also be added to a task by a user.

It will be appreciated that a user may generate a workflow de novo, or may use portions of previously generated workflows in combination with newly created workflow portions, or may use a workflow which has been previously generated in totality (such as a template). In this case, there may be provided a customer user interface having a higher level of simplicity with regard to the generation of workflows as compared with the backend administration user interfaces shown herein.

In other embodiments of the system, the workflow is generated as a backend service provided by an entity coordinating the system. In these embodiments, human intervention may be required or preferred so as to generate an efficient and usable workflow.

Once the workflow is set, the system may be configured to allow the project originator to select and retain the first task executor, most of the task executors, or all of the task executors. In some embodiments, the system is configured to require only that the first task executor is identified and retained, with the project originator being permitted to select and retain task executors for other tasks at a later time. Alternatively, the systems may be configured to automatically assign a task executor, and without any need for selection on the part of the project originator.

The system may be configured to allow a task executor's accounts to be flagged for a policy infringement. As an example of any infringement, a task executor may accept a task, but then fail to commence work in a timely manner. In such a case, the task may be reassigned automatically by the system, or manually by the project originator. The original task executor's rating may be negatively impacted, and the policy infringement flag maintained for a period of time. In some circumstances, the task is not completed on time because of a circumstance beyond the control of the task executor. For example, a project originator may delay in selecting an option or approving a task resulting in the workflow being temporarily halted. The task executor can therefore no longer deliver the work product at that point in time. The system may be automatically configured to make no penalty against that task executor. Alternatively, the system may be configured such that a task delivery counter starts as soon as a freelancer agrees to accept the task.

In any event, at some point in time the workflow is directed to commence by the project originator. The workflow software passes the first task to the first task executor. Typically, the task executor logs into the workflow system platform (generally hosted on a remote server) using credentials previously provided (such as username and password). Upon successful login, the task executor is presented with a dashboard of new tasks, pending tasks, and completed tasks. The new task may be clicked, with the task executor being presented with details of the task in written form. For example, the task may be written as “Prepare a logo for a new childcare center. Primary colors are to be used. Children's alphabet building blocks should form the foundation of the logo. The logo is to be used on full color brochures, business cards and website. The project originator has requested three options be provided in .jpg format by Sep. 25, 2017. One of the three options will be selected, and you may be required to revise the selected logo under instruction by the project originator”.

The user interface presented to the task executor may be configured to display the entire project workflow so as to provide a broader view of the overall project.

The first task executor commences working on the design on his/her computer, and when finished uploads the three alternative logos to the common virtual drive of the project via the system platform. The project originator is alerted to the upload on his/her dashboard, and accesses the common virtual drive to view the three options. The project originator prefers the first option, clicks on the first logo, and then actuates a “continue workflow” virtual button on the dashboard. The workflow software then sends task instructions to (i) a graphic designer task executor with instructions to prepare a brochure and business cards, (ii) a web designer to produce a website, and (iii) a web developer to code the website after it's designed. The tasks (i), (ii) and (iii) are executed in parallel since commencement of one is not dependent on completion of the other.

In one embodiment of the first aspect, the user interface is configured to output workflow progress information. The project originator dashboard may show the overall workflow, and any tasks that are completed may be highlighted in a color. Tasks which are behind schedule may be highlighted in a different color. Tasks which are awaiting input from the project originator may be highlighted in a different color again. This dashboard view provides the project originator with an overall view of progress of the entire project, and therefore highlights any problem tasks or actions required. In one embodiment of the first aspect, the workflow progress information is in a simplified graphical format.

The dashboard may provide communication means between the project originator and a task executor. For example, clicking on a task on the project originator dashboard may bring up a text input box allowing for a text-based message to be transmitted to a computer of a task executor. Alternatively, the system may be configured to provide access to a video chat option (either native, or via a third-party provider) between the parties. The system may be further configured to allow a task executor to message a project originator or another task executor via the system platform.

In one embodiment of the first aspect, the workflow management system comprises one more workflow templates comprising workflow information readable by the workflow management software. Many projects will conform to certain schemes and therefore are amenable to reduction to a template. For example, many small businesses will be faced with administering similar projects such as generating marketing material, instigating a social media campaign, designing and constructing new product prototypes, instigating market research and generating reports, preparing materials for a trade show, and the like. In some embodiments the system platform presents a series of templates which are identifiable according to a workflow product, such as “annual report”, “social media campaign”, “new corporate entity”, “new product launch”, “new product design” and the like.

In one embodiment of the first aspect, the workflow templates are user-editable. In this way, a project originator may be spared from creating a new workflow de novo, but is enabled to customize a template workflow as required.

As will be appreciated from the above, the present system may be embodied in the form of a computer network comprising two or more task executor computers in data communication with the coordinating computer. Moreover, a project originator computer may be in data communication with the coordinating computer. The coordinating computer thus performs a central function of connecting the system participants. In some embodiments the participants may be connected by way of LAN or WAN, this being possible where the system is implemented within an organization. More typically, the system is implemented across the Internet with such embodiments allowing participants not otherwise associated or not otherwise in network communication.

A network of the present systems may be implemented by wired means, such as twisted pair wire, computer networking cabling (wired Ethernet as defined by IEEE 802.3), coaxial cable, ITU-T G.hn technology, optical fiber. The term “wired”, and its derivatives may be used to describe circuits, devices, systems, methods, techniques, communications channels, etc., that may communicate data through the use of modulated electromagnetic radiation through a solid medium.

In addition or alternatively the network may be implemented by wireless means including terrestrial microwave, communications satellite, cellular and PCS systems, radio and spread spectrum technologies such the IEE 802.11 protocols. In the context of this document, the term “wireless” and its derivatives may be used to describe circuits, devices, systems, methods, techniques, communications channels, etc., that may communicate data through the use of modulated electromagnetic radiation through a non-solid medium.

The network may implement any suitable communications protocol including an ethernet protocol, TCP/IP (including IPv4 and IPv6), Synchronous Optical Networking (SONET) and Synchronous Digital Hierarchy (SDH).

In one embodiment of the first aspect, the two or more task executor computers each comprise a user interface configured to allow access to task requests received, tasks requests accepted, task-related scheduling information, task-related starting materials, task-related income, task-related comments or questions, and task-related ratings. Thus, a task executor is enabled to maintain an overview of tasks with an aim of schedule the tasks, and also interacting with other participants of a project. As will be appreciated, human task executors are best considered as more than simply a robotic executor of a defined task. Project teams work best where communication between team members is possible, if not actively facilitated. The present systems may therefore be configured in some embodiments to provide a forum not only for a project originator to fully communicate a task, but furthermore to allow for provision of input in the form of comments, advice, opinion, queries, and the like from task executors.

In some embodiments of the invention, the task executor is a computer programmed to execute a task. Details of such a computer may be included on the system database, including the computers “skills”. Thus, a project originator may select a computer that is capable of executing a required task as a task executor. As will be appreciated, such tasks are unlikely to require any significant creativity or intelligence. Instead, the computer may be utilized to perform tasks such as data analysis, preparation of graphs from raw data, conversion of files from one format to another, dispatching bulk electronic communications, generation of a brochure based on a brochure template, and the like. In this regard, the skilled person will appreciate the potential applicability of online services such as Zapier (Zapier Inc).

Task executors will require payment for work conducted in accordance with the system, and accordingly the system may be configured to handle payments between project originators and task executors. In the course of registering to participate in the system, a task executor may be prompted to provide details of a funds receiving account, such as a bank account or a PayPal™ account. Similarly, a project originator may be prompted to provide a funds debiting account which may be drawn from (optionally automatically by the system) to pay a task executor. Thus, upon successful completion of a task, the project originator may be prompted by the system to approve payment of a task executor and upon received of the approval (typically via user interface) funds are electronically transmitted from the project originator account to the task executor account.

As an alternative to direct payment between a project originator and a task executor, the project originator may transfer funds to an account of an entity administering the present system. That entity may in turn transfer funds to the task executor. Optionally, a commission may be taken by the entity as funds pass through its account.

In some embodiments, the system is configured to receive payment for the entire project from the project originator, and to trigger payments to task executors as their tasks are completed and approved by the task originator. This configuration is advantageous because it relieves the project originator of significant administrative burden. Furthermore, payments are essentially retained in escrow until the task is performed to an acceptable level, this given the project originator some protection against a rogue task administrator. The system and platform may be configured to integrate with third-party payment providers to fenable automated payments using any payment method available (such as bank wire transfers, cryptocurrency, Transferwise, Deel, etc.). An escrow system provides a task executor with an assurance that funds are available for payment, and protects the task executor from the unscrupulous activity of a rogue project originator. Payout prices may change over time in order to optimize task routing efficiency. Accordingly, the margin taken by a coordinating entity may be dynamic and may not necessarily be explicitly revealed.

The present invention will now be described by reference to other aspects directed to computer-implemented methods (as a second aspect, and as a sixth aspect), processor executable software (as a third aspect), computer storage medium (as a fourth aspect), and a computer (as a fifth aspect). It should be recognized that features of the invention discussed supra with regard to the present systems (the first aspect) may be applicable to any one or more of the second, third, fourth, fifth and sixth aspects. It will be understood that each of those features may be independently combined with any feature of the second, third, fourth, fifth and sixth aspects.

In a second aspect, there is provided by the present invention a computer-implemented method for executing a desired workflow or providing a desired workflow deliverable, the method comprising the steps of: entering into a workflow management software a desired workflow or a desired workflow deliverable, causing or allowing the workflow management software to define two or more requisite tasks, and a task executor for each of the two or more requisite tasks by reference to a database of human and/or computer task executors, and causing or allowing the workflow management software to direct the execution of the two or more requisite tasks by the relevant task executors.

In one embodiment of the second aspect, the workflow management software directs the execution of the two or more tasks in series.

In one embodiment of the second aspect, the workflow management software causes or allows a task deliverable produced by a first task executor to be accessible by a second human task executor.

In one embodiment of the second aspect, the workflow management software directs the execution of two of the two of more tasks in parallel.

In one embodiment of the second aspect, the workflow management software causes or allows a task deliverable to be accessible to a human project originator.

In one embodiment of the second aspect, the computer-implemented method comprises inputting a decision into the workflow management software before one or more tasks is/are commenced.

In one embodiment of the second aspect, the decision is the selection of a preferred task deliverable from two or more alternative task deliverables.

In one embodiment of the second aspect, the decision is whether any task deliverable is acceptable.

In one embodiment of the second aspect, the computer-implemented method comprises the step of associating a comment with a task deliverable via the workflow management software, the comment being accessible by the task executor responsible for the task deliverable.

In one embodiment of the second aspect, the computer-implemented method comprises duplex electronic communication between the human project originator and the task executor responsible for the task deliverable via the workflow management software.

In one embodiment of the second aspect, the workflow management software is configured to (i) present a human user interface on a computer of a human task executor, and/or (ii) present a human user interface on a computer of a human project originator, and the method comprises the step presenting the interface on the computer of a human task executor, and/or the computer of a human project originator.

In one embodiment of the second aspect, the computer-implemented method comprises the step of causing or allowing a human user to comprehend the information, or question, or option presented on the human user interface.

In one embodiment of the second aspect, the computer-implemented method comprises the step of causing or allowing a human user to enter the input, or response or selection into the human user interface.

In one embodiment of the second aspect, the computer-implemented method comprises the step of associating one or more task parameters to each of the two or more requisite tasks via the workflow management software.

In one embodiment of the second aspect, the task parameters is/are specified by a human project originator or by the workflow management software.

In one embodiment of the second aspect, the one or more task parameters is/are selected from the group consisting of: task executor skill, task executor experience, task executor rating, task executor price, project originator specified price, task executor delivery time, project originator revision rule, required format of the task deliverable,

In one embodiment of the second aspect, the computer-implemented method of any one of claims 34 to 49, comprising the step of inputting a rating of a task executor into the workflow management software, and causing or allowing the workflow management software to associate the rating with the task executor on the database.

In one embodiment of the second aspect, the computer-implemented method comprises the step of causing or allowing the workflow management software to import data from the software of a task executor computer, or the software of another computer.

In one embodiment of the second aspect, the computer-implemented method comprises the step of causing or allowing the workflow management software to export data to the software of a task executor computer, or any other software.

In one embodiment of the second aspect, the desired workflow is defined by reference to a standardized workflow specification

In one embodiment of the second aspect, the standardized workflow specification comprises a graphical component.

In one embodiment of the second aspect, the standardized workflow specification is selected from any of those mentioned elsewhere herein.

In one embodiment of the second aspect, the workflow management software is configured to provide a graphical and/or text-based user interface.

In one embodiment of the second aspect, the computer-implemented method comprises the step of inputting a desired workflow into the user interface.

In one embodiment of the second aspect, the computer-implemented method comprises the step of causing or allowing the user interface is configured to output workflow progress information.

In one embodiment of the second aspect, the workflow progress information is in a simplified graphical format.

In one embodiment of the second aspect, the computer-implemented method comprises providing one more workflow templates comprising workflow information readable by the workflow management software, and selecting one of the one or more workflow templates.

In one embodiment of the second aspect, the computer-implemented method comprises the step of selecting a workflow template based on a desired workflow product.

In one embodiment of the second aspect, the computer-implemented method comprises the step of editing a workflow template.

In one embodiment of the second aspect, the computer-implemented method comprises causing or allowing two or more task executor computers to form data communication with a coordinating computer which executes the workflow management software.

In one embodiment of the second aspect, the two or more task executor computers each comprise a user interface configured to allow access to task requests received, tasks requests accepted, task-related scheduling information, task-related starting materials, task-related income, task-related comments or questions, and task-related ratings, and a human user of the one or more task executor computers views the task requests received, tasks requests accepted, task-related scheduling information, task-related starting materials, task-related income, task-related comments or questions, and task-related ratings.

In one embodiment of the second aspect, the two or more task executor computers each comprise a user interface configured to receive from a human task executor information pertaining to task-related skills, task-related experience, task-related pricing, availability to receive new tasks, task-related comments or questions, and a human user of two or more task executor computers inputs information pertaining to task-related skills, task-related experience, task-related pricing, availability to receive new tasks, task-related comments or questions.

In one embodiment of the second aspect, the data communication is by way of secure connection over the Internet.

In a third aspect of the invention there is provided processor-executable software for managing a workflow, the software being configured to input a desired workflow or a desired workflow deliverable and by reference thereto define two or more requisite tasks, and interrogate a database of human and/or computer task executors to identify two or more task executors each capable of executing one of the two or more requisite tasks.

In one embodiment of the third aspect, the processor-executable software is configured to direct the execution of two of the two or more tasks in series.

In one embodiment of the third aspect, the processor-executable software is configured to allow a task deliverable produced by a first task executor to be accessible by a second human task executor.

In one embodiment of the third aspect, the processor-executable software is configured to direct the execution of two of the two of more tasks in parallel.

In one embodiment of the third aspect, the processor-executable software is configured to allow a task deliverable to be accessible to a human project originator.

In one embodiment of the third aspect, the processor-executable software is configured to request a decision by a human project originator before one or more tasks is/are commenced.

In one embodiment of the third aspect, the decision is the selection of a preferred task deliverable from two or more alternative task deliverables.

In one embodiment of the third aspect, the decision is whether any task deliverable is acceptable.

In one embodiment of the third aspect, the processor-executable software is configured to allow a human project originator to associate a comment with a task deliverable, the comment being accessible by the task executor responsible for the task deliverable.

In one embodiment of the third aspect, the processor-executable software is configured to allow for duplex electronic communication between the human project originator and the task executor responsible for the task deliverable.

In one embodiment of the third aspect, the workflow management software is configured to (i) present a human user interface on a computer of a human task executor, and/or (ii) present a human user interface on a computer of a human project originator, and the method comprises the step presenting the interface on the computer of a human task executor, and/or the computer of a human project originator.

In one embodiment of the third aspect, the processor-executable software is configured to cause or allow a human user to comprehend the information, or question, or option presented on the human user interface.

In one embodiment of the third aspect, the processor-executable software is configured to cause or allow a human user to enter the input, or response or selection into the human user interface.

In one embodiment of the third aspect, each of the two or more requisite tasks has one or more task parameters associated therewith.

In one embodiment of the third aspect, the one or more task parameters is/are specified by a human project originator or by the processor-executable software.

In one embodiment of the third aspect, the one or more task parameters is/are selected from the group consisting of: task executor skill, task executor experience, task executor rating, task executor price, project originator specified price, task executor delivery time, project originator revision rule, required format of the task deliverable,

In one embodiment of the third aspect, the processor-executable software is configured to receive a rating of a task executor transmitted by a project originator, and to associate the rating with the executor on the database.

In one embodiment of the third aspect, the processor-executable software is configured to facilitate data import into the workflow management software from a task executor computer, or any other software, via a software interface.

In one embodiment of the third aspect, the processor-executable software is configured to facilitate data export to the software of a task executor computer, or any other software, via a software interface.

In one embodiment of the third aspect, the desired workflow is defined by reference to a standardized workflow specification

In one embodiment of the third aspect, the standardized workflow specification comprises a graphical component.

In one embodiment of the third aspect, the standardized workflow specification is selected from any of the mentioned elsewhere herein.

In one embodiment of the third aspect, the processor-executable software is configured to provide a graphical and/or text-based user interface.

In one embodiment of the third aspect, wherein the user interface is configured to accept input relating to the desired workflow.

In one embodiment of the third aspect, the user interface is configured to output workflow progress information.

In one embodiment of the third aspect, the workflow progress information is in a simplified graphical format.

In one embodiment of the third aspect, the processor-executable software is configured to read a workflow template comprising workflow information.

In one embodiment of the third aspect, the one more workflow templates is/are identifiable according to a workflow product.

In one embodiment of the third aspect, the workflow templates are user-editable.

In one embodiment of the third aspect, the processor-executable software configured to cause or allow two or more task executor computers to be in data communication with the coordinating computer.

In one embodiment of the third aspect, the two or more task executor computers each comprise a user interface configured to allow access to task requests received, tasks requests accepted, task-related scheduling information, task-related starting materials, task-related income, task-related comments or questions, and task-related ratings.

In one embodiment of the third aspect, the two or more task executor computers each comprise a user interface configured to receive from a human task executor information pertaining to task-related skills, task-related experience, task-related pricing, availability to receive new tasks, task-related comments or questions.

In one embodiment of the third aspect, the data communication is by way of secure connection over the Internet.

In a fourth aspect, the present invention provides a computer storage medium having stored thereon the processor-executable software of any embodiment of the third aspect.

In a fifth aspect, the present invention provides a computer comprising the computer storage medium of the fourth aspect.

In a sixth aspect, the present invention provides the computer-implemented method of any embodiment of the second aspect, comprising use of the system of any embodiment of the first aspect, or the software of any embodiment of the third aspect, or the computer of the fifth aspect.

The methods and systems described herein may be deployed in part or in whole through a computer that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a computer that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, computers, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, computers, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other network types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon.

Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on computer readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks. Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on computers through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such computers may include, but may not be limited to, personal digital assistants, laptops, personal computers, mobile phones, other handheld computing devices, wired or wireless communication devices, transducers, chips, calculators, satellites, tablet PCs, electronic books, gadgets, electronic devices, devices having artificial intelligence, computing devices, networking equipment, servers, routers and the like.

Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals.

It will further be appreciated that one or more of the processes may be realized as a computer executable code capable of being executed on a computer readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

### BRIEF DESCRIPTION OF THE DRAWINGS

The present invention will now be more fully described by reference to the following non-limiting embodiments, and in which:

FIG. 1 is a network diagram of one embodiment of the present invention.

FIG. 2 depicts a flow chart detailing a process for task flow progression for three tasks which require approval prior to the initiation of subsequent tasks, a progression present as an option of the platform and system of the present invention.

FIG. 3 depicts a flow chart detailing a process for task flow progression in which the first two tasks must be completed (worked on simultaneously) before a third task may be initiated, completed, and approved (or revised), the progression afforded as an option of the platform and system of the present invention.

FIG. 4 depicts a flow chart detailing a process for task flow progression as provided by the present invention in which the first two tasks must be completed before a third task is initiated, and the third task must be completed before all three tasks are reviewed and approved or revisions are requested, indicating a specific codependence of the three tasks for the successful completion of the project.

FIG. 5 depicts a flow chart detailing a more complicated task flow example in which task trees, as implemented by the platform and system of the present invention, are laid out for a total of six tasks with differing dependencies and approval mechanisms.

FIG. 6 shows a screenshot of the platform of the present invention depicting an exemplary workflow process for a logo design.

FIG. 7 depicts a screenshot of the platform of the present invention showing a workflow process for the creation of an eBook, as well as the input mechanism for each task's description as afforded by the process and platform of the present invention.

FIG. 8 shows a screenshot of the platform of the present invention exhibiting a workflow process for lead generation for sales as implemented by the process of the present invention.

FIG. 9 shows a screenshot of the web-based platform of the present invention, depicting options for bundles which expedite workflow process creation for businesses.

FIG. 10 shows a screenshot of the platform of the present invention, exhibiting a “buy now” button for a branding bundle purchase.

FIG. 11 shows a screenshot of the platform of the present invention, exhibiting a progress screen for a logo creation and implementation workflow as afforded by the process of the present invention.

FIG. 12 shows a screenshot of an example message conveyed to a task executor providing the option for him/her to view and then accept or reject the proposed task via the platform of the present invention.

FIG. 13 shows a screenshot of a comment screen at which task originators can add additional information pertaining to tasks for task executors, as well as review submissions via the platform of the present invention.

FIG. 14 shows a screenshot of the submission review screen of the platform of the present invention, depicting approve and revise options for the task originator to select upon viewing submitted work provided by hired task executors.

FIG. 15 shows a bundle selection screenshot as depicted on the platform of the present invention.

FIG. 16 shows a screenshot of a pending task screen as depicted to a task originator on the platform of the present invention.

FIG. 17A exhibits a first portion of a flow chart detailing the backend dispatch logic flow of the system and method of the present invention.

FIG. 17B exhibits a second portion of the flow chart of FIG. 17A, detailing the backend dispatch logic flow of the system and method of the present invention.

### DETAILED DESCRIPTION OF THE PREFERRED EMBODIMENTS OF THE PRESENT INVENTION

The present invention is a workflow management solution, embodied in a system and platform, configured to facilitate the execution of individual tasks of a project by task executors in accordance with the specific goals of a given project as indicated by a project originator. The platform expedites the delegation process of portions of the project to differing task executors based on their pertinent experience in the proposed task at hand, independent of the overall project goal if needed. The system and platform of the present invention preferably employs artificial intelligence (machine learning) to inform the proposal of specific task executors as ideal candidates with which the task originator should select for hire to achieve the optimal outcome of the overall project. The system employs a unique rating system, implemented in the backend of the system, to facilitate an automatic narrowing of a list of available task executors based on criteria supplied by the task originator as detailed below.

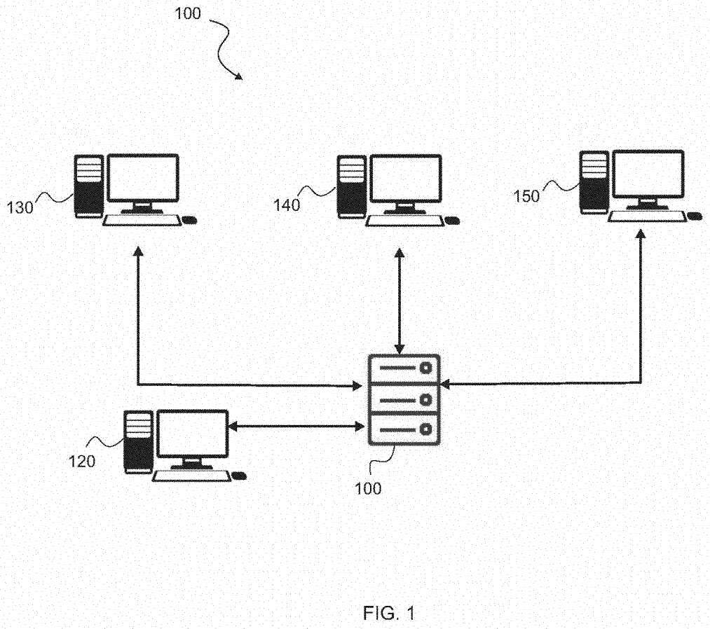

Turning firstly to FIG. 1 there is shown an exemplary network 100 which is useful in the coordination of a project requiring multiple task executors and under the general direction of a project originator. The network 100 comprises a central coordinating computer 110 administered by a coordinating entity. The central coordinating computer 100 comprises workflow management software, and also networking software allowing data communication between a project originator computer 120, and task executor computers 130, 140, 150. In this embodiment, all communication (as designated by the double-headed arrows shown in FIG. 1) between project originator computer 120, and task executor computers 130, 140, 150 is via a secure Internet connection.

To initiate a workflow for a project, a project originator logs into his/her account on the workflow platform of the present invention hosted on the central coordinating computer 100 via the computer 120. A user interface is presented to the project originator, allowing for the selection of “new workflow”. The project manner is then presented with a user interface allowing for the selection of a workflow template. The manager initiates a new workflow by selecting a relevant template. A graphical user interface shows the workflow, including the various tasks involved, and how the tasks are connected in terms of dependency. The project originator reviews the workflow and decides it is appropriate for the project.

For each task of the project, the project originator selects a task executor. Candidates for the position of task executor for the selected task are preferably automatically populated based on the indicated category of task as indicated by the project originator (or automatically based on analysis of the project title), and ideal candidates based on a scoring system are designated as preferred. Upon selecting the first task, the database of the central coordinating computer 100 presents on the user interface a number of candidates to the project originator, sorted by rating without necessitating manual input of desired input criteria/search parameters. Ideal candidates (for task executor(s)) are automatically sought and returned by the system in accordance with the scope of the task presented to the system. The ratings of each task executor are dynamic based on the rating the freelancer has earned for prior work for the specific task that the customer (project originator) is requesting. The machine learning as mandated by the algorithm of the system of the present invention is configured to automatically allocate work to the highest-rated, most suitable task executors first and trigger recruiting workflows if there is a shortage of high-quality candidates. Prices may be configured to adjust dynamically based on availability of high-suitability freelance candidates. Ideally, users of the platform and system of the present invention need not manually select a rating and experience level in order to obtain the best task executors available for the proposed task(s).

The system preferably takes three ratings into account, and other factors, in order to make the decision as to who the ideal task executor should be for a given task. The three ratings are as follows:
A Net Promoter Score (NPS) or Qualitative score: customer rates each task completed on a scale from 1 to 5, effectively a customer feedback score;
A Communication score; and
A Delivery time score;

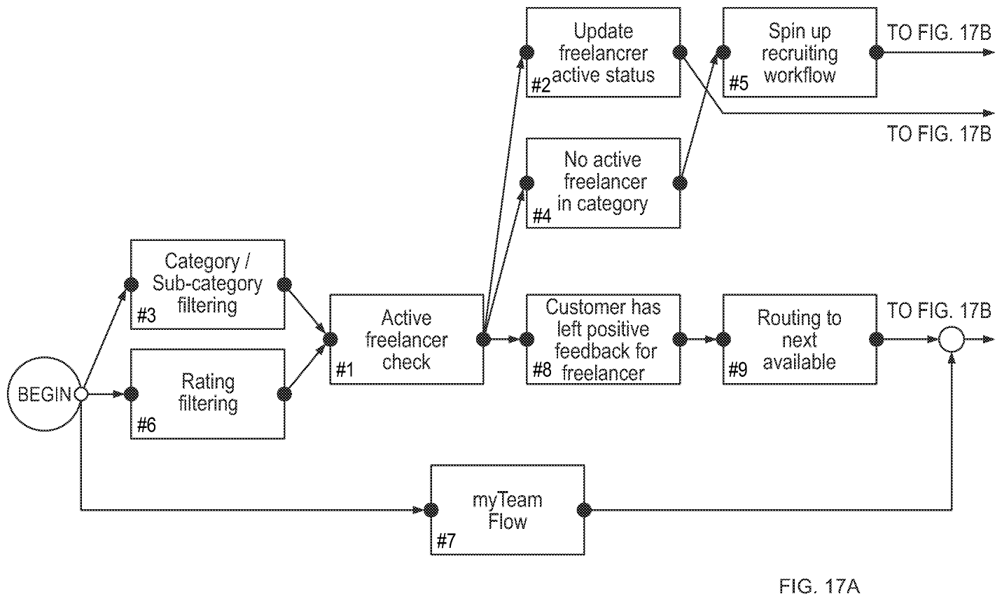

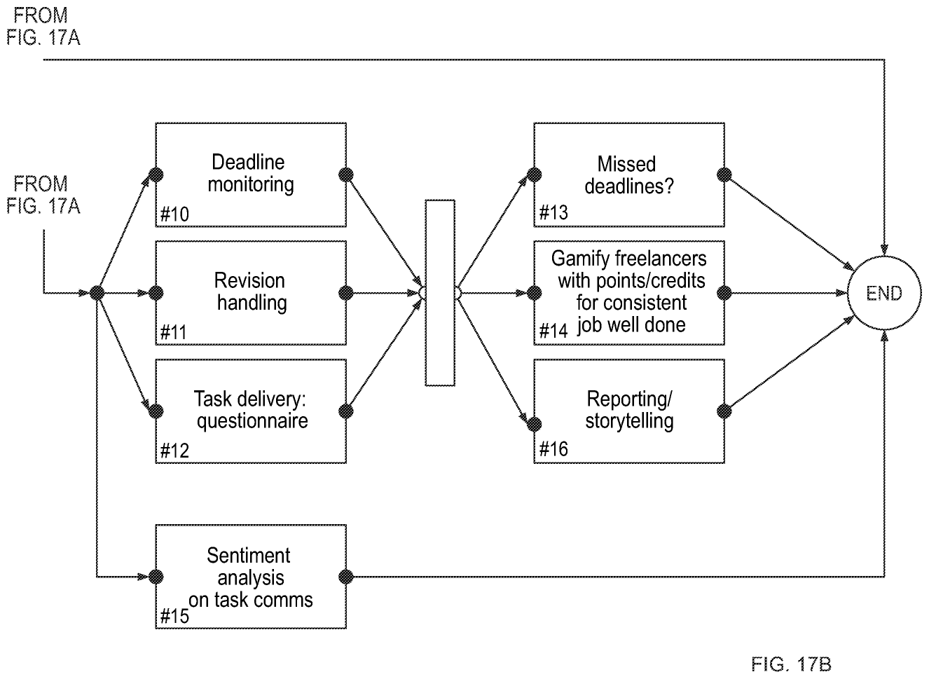

The system then analyzes the specific task requirements that the project originator is requesting against how well a given task executor has delivered similar tasks in the past, and then creates a weighting to allocate work to them. The algorithm is additionally configured to measure their predicted availability and current workload as depicted in FIG. 17 to inform the decision.

The delivery time score is informed by the intelligence for ‘deadline monitoring’ that follows up with task executors automatically for failing to deliver on time.

The data informed by the aforementioned three scores is used by the system to build a Markov Chain model in the form of a table containing the dispatching workflow states and the transition probability between them, considering a one-hour timeframe. It should be noted that the dispatching diagram of FIG. 17 is one example of a live snapshot of a dispatching workflow that the machine learning algorithm decided to use in one instance based on the Markov Chain processes.

For Example:

| MC | State 1 | State 2 | State 3 |
|---|---|---|---|
| State 1 | .25 | .5 | .5 |
| State 2 | .20 | .10 | .80 |
| State 3 | .30 | .10 | .60 |

State 1-−60 min->State 1-10 min->State 3, which has a total weight of 70 minutes and a Net Promoter Score of 6

Combining all paths results in a graph for which the Markov Chain table can be used to predict transactions, which results in a model for self-exploratory theoretical agents using the platform. Both the real world and the virtual agent's behavior are used to train a Neural Network which decides which, if any, feedback action should be taken for a given task process. This is an automated process, which provides for weekly updates on the trained algorithm of the system and platform of the present invention and updates the net promoter scores accordingly.

Finally, the system of the present invention also retains some basic hardcoded events like “send a reminder a day before the due date” or “request Net Promoter Score every two days after task completion” and other conventional automated back-end activities.

In instances of project originator dissatisfaction, untimely completion of tasks, or similar faults, the system is configured to automatically lower the score of the assigned task executor(s) so that the system would automatically be less likely to choose the task executor in the future for a similarly assigned task.

As depicted in FIG. 17, the presentation of ideal candidates for hire as task executors, referenced in the chart as “freelancers,” is based on a wide variety of criteria, including, but not limited to: current freelancer status (available, or currently hired), category and sub-category of freelancer (is there a freelancer available for hire trained in the type of work requested, referenced as a category), and rating filtering based on the NPS score previously outlined. Current status of the freelancer can be determined with the machine learning of the system by the algorithm instructing the system to discern which platforms on which the freelancer(s) are most likely to be responsive, automatically messaging them when they appear as “available for contact/communication” on the platform, and analyzing the response of the freelancer(s) to find out if they are in fact unavailable or available, and for how long they may be unavailable. Only the AI of the system of the present invention can facilitate this determination in an automated fashion because the system is capable of referring to a freelancer's previous actions to determine whether a freelancer seems to be less active “than usual,” and also by figuring out which platform on which they are most responsive over time.

After the task is performed by the task executor hired by a project originator for a given task of the project, the task executor is evaluated on the following factors:
Deadline monitoring—did the task executor complete the task within the deadline assigned? Was the task performed ahead of schedule? If it was completed after the deadline, was communication (between project originator and task executor) regarding the task adequate?
Revision handling—were revisions, as requested by the task originator based on their review of the work, handled in a timely manner and completed to the satisfaction of the project originator?
Task Delivery—was the product or outcome of the task assigned delivered in the agreed-upon fashion (file format, type, size, etc.)? This feedback is preferably obtained via a questionnaire to be completed by the project originator after project completion.
Sentiment Analysis on task communications—Did the task executor communicate effectively and kindly with the task originator in and any all communications pertaining to the assigned task? Machine learning is employed to analyze the communications of the task executor with the task originator to discern the emotional states of each party and factor-in stress levels when determining this score. Task executors indicating high-stress communications may have similar tasks be reallocated to other candidates for future tasks.

The results of these factors may be employed in a subsequent point or credit system to facilitate gamification of the platform for task executors. In such a manner, freelancers may be rewarded for consistent positive performance with perks in addition to the previously agreed-upon payment from the task originator. Additionally, results from the aforementioned factors are preferably input into reporting, stored in a database, for use in selection criteria for future tasks.

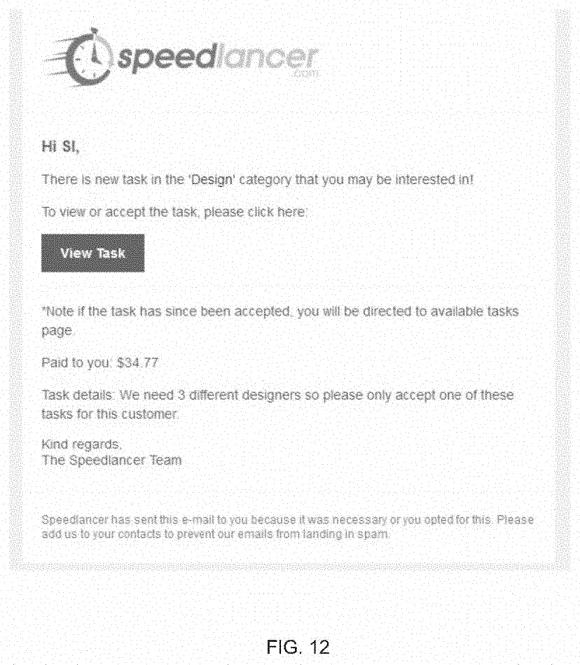

The project originator selects one task executor, and the central coordinating computer sends an electronic message to the task executor's computer 130 requesting participation in the process as shown in FIG. 12. Alternately, in some embodiments of the present invention, the platform may employ machine learning to automatically select an ideal candidate from a list of available candidates on behalf of the project originator in accordance with the rating system informed by machine learning. The candidates may or may not require approval by the project originator. The task executor sends an acceptance reply to the central coordinating computer 100 and that task executor becomes a confirmed team member. Confirmation of the task executor's enrolment as a team member is conveyed to the user interface on project originator's computer 120.

The process of task executor selection is continued for the selection of a second task executor (via computer 140), and the third computer (via computer 150). When all task executors are enrolled, the workflow set up is complete. Each task executor is able to view the entire workflow on his/her computer 120, 140 or 150 so as to gain a more complete understanding of the overall project. Alternatively, the system may be configured such that a task is routed to a task executor only when the task is ready to be started.

The project originator then (via user interface on computer 120) enters instructions for each task executor, the instructions being visible on each of computer 130, 140, 150. Task parameters relating to any requirement for review, specification of file format in which the task product is to be saved etc. are entered with each task.

At this point, the workflow is defined, the task executors selected and briefed. Via user interface on computer 120, the project originator selects “start” to trigger central coordinating computer 100 to transmit an electronic notification to computer 130 instructing the task executor to commence work. The first task executor receives the notification and commences work. Once the work is complete, the first task executor uploads the task product to a dedicated virtual drive hosted on central coordinating computer 100.

The upload is detected by the workflow management software of the central coordinating computer 100, and a notification is transmitted to the computer 120 requesting the project originator to review the uploaded work product. Upon manual review and approval, the project originator clicks virtual button “approve” on user interface of computer 120, this act causing the transmission of a notification from central coordinating computer 100 to second task executor computer 140, the notification directing the second task executor to access the work product of the first task executor and to perform the required task therewith. The “approve” instruction further triggers payment of the required fee from the project originator's funding account to the first task executor's receiving account (as discussed elsewhere herein, the system may be configured to route payment through a bank account of the system administration entity) automatically per instruction of the platform. Part of the fee previously agreed between the project originator and the first task executor is retained as a commission by the entity administering the central coordinating computer 100.

Once the work of the second task executor is complete, the second task executor uploads the task product to the dedicated virtual drive hosted on central coordinating computer 100.

The upload is detected by the workflow management software of the present invention running on the central coordinating computer 100, and a notification is transmitted to the computer 120 requesting the project originator to review the uploaded work product of the second task executor. The project originator clicks virtual button “approve” on user interface of computer 120, this act causing the transmission of a notification from central coordinating computer 100 to a third task executor computer 140, the notification directing the third task executor to access the work product of the first task executor and to perform the required task therewith. The agreed fee is paid to the second task executor automatically as instructed by the platform, and the commission to the coordinating entity.

Once the work of the third task executor is complete, the third task executor uploads the task product to the dedicated virtual drive hosted on central coordinating computer 100.

The upload is detected by the workflow management software of the central coordinating computer 100, and a notification is transmitted to the computer 120 requesting the project originator to review the uploaded work product (being the final work product) of the third task executor. The project originator clicks virtual button “approve” on user interface of computer 120, this act causing payment of the agreed fee to the third task executor automatically, and the commission to the coordinating entity.

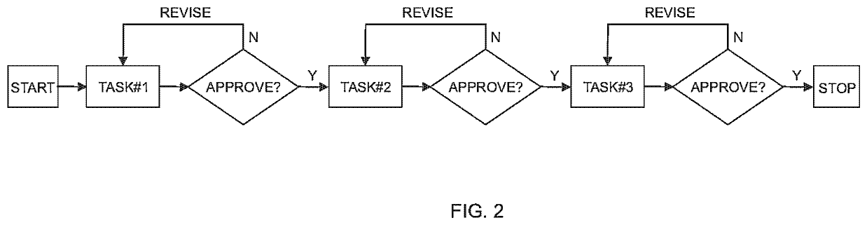

The exemplary workflow above, having three tasks with a revision loop for each task is shown in FIG. 2.

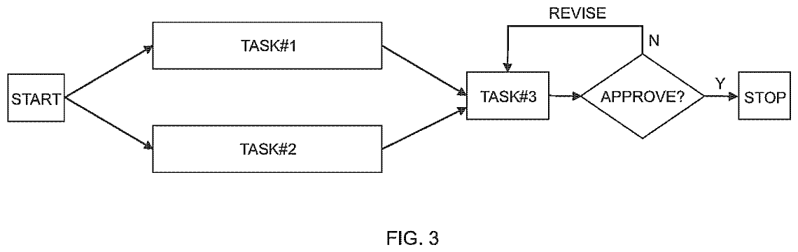

FIG. 3 shows a workflow whereby TASK #1 and TASK #2 are executed in parallel. The two task products of TASK #1 and TASK #2 are required as starting materials for TASK #3. The project originator either approves or directs revision of the work product of TASK #3. The approved work product of TASK #3 is the final project product. When a hashtag reference is used, the task executor assigned to the task is given permission by the system to access the hashtagged task. The hashtag becomes clickable with the corresponding task title shown, such that the task executor is allowed full access to view the communications and submissions made in relation to that task, which is relevant to their current task.

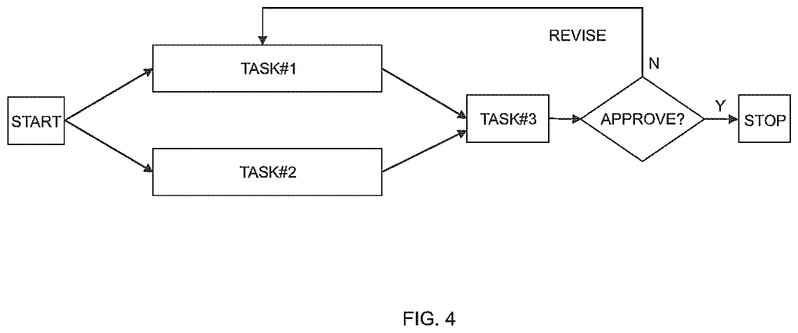

FIG. 4 shows a variation of the workflow of FIG. 3, and in which the project originator only wishes to review the work product of TASK #1 when reviewing the final product (produced by TASK #3). Where revision is required, the executor of TASK #1 makes the appropriate amendments, after which TASK #3 is repeated before being passed to the project originator for approval.

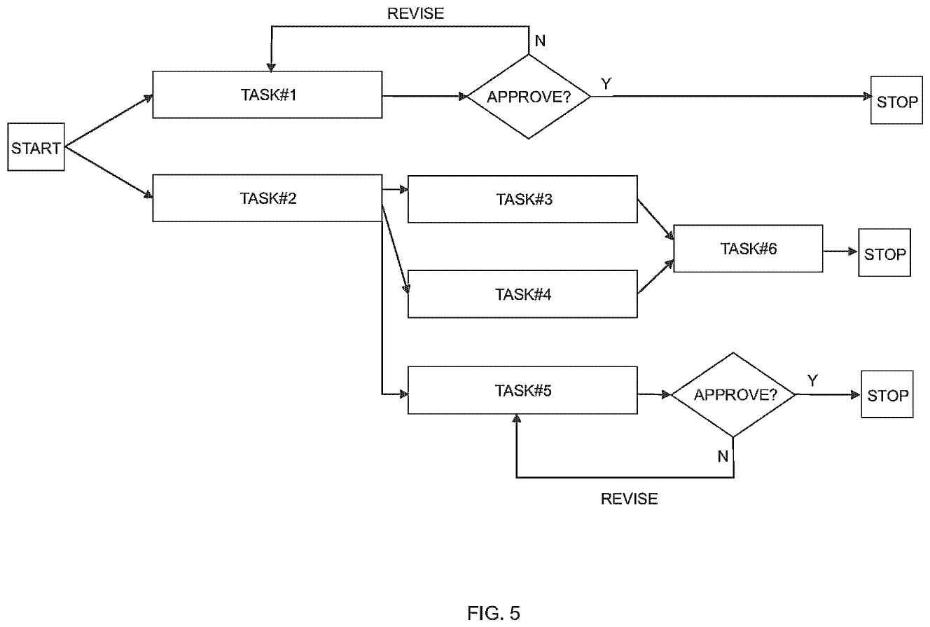

FIG. 5 shows a more complex workflow that results in three separate final work products.

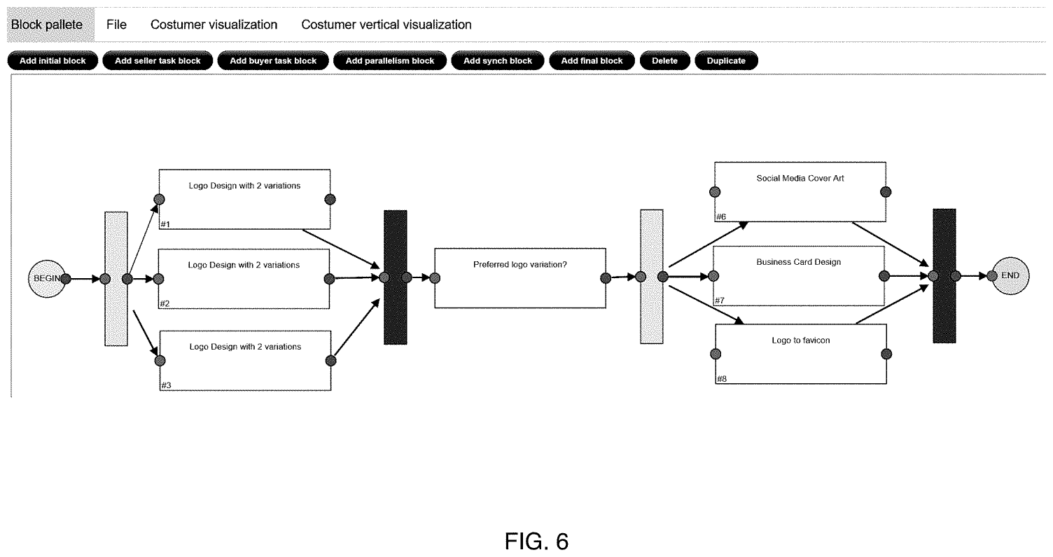

FIG. 6 is a screenshot of an interface as seen by a backend administrator of the present system. The project originator is termed a “customer” on this drawing. In this example, the customer is permitted to review alternative logo designs in a branding project. Upon selection of the preferred logo, the logo is sent for incorporation into each of (i) social media cover art, (ii) business card design, and (iii) conversion to a favicon file. In this embodiment, the central box is highlighted, and is characterized as a customer task (as distinct from the other tasks which are third party task executors). When the central box is highlighted a task description is provided “Hi there! Please select which logo is you preferred version before we continue with the remainder of your Branding Bundle”, as shown at the upper right-hand corner (as drawn) of the interface. In this embodiment, it will be noted that the customer performs no significant management role and is instead prompted in this workflow only to make a selection.

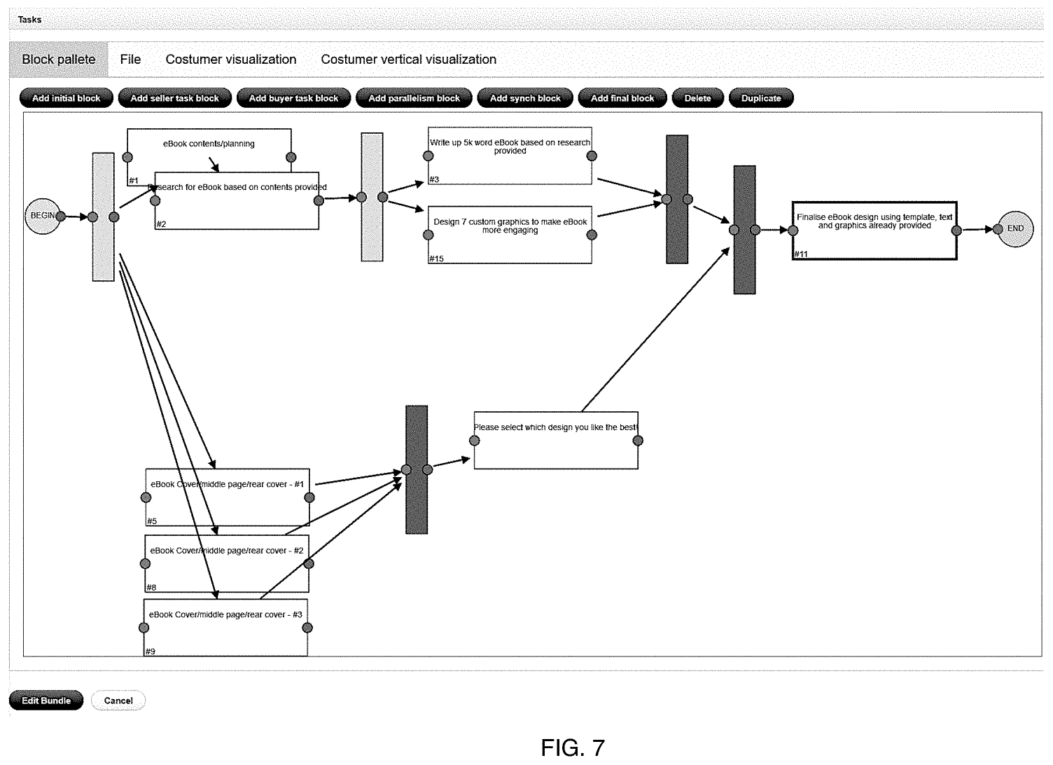

FIG. 7 is a screenshot of a backend administrator interface for a workflow directed to the production of an eBook. The highlighted box is a task entitled “Write up SK eBook based on research provided. At the bottom of the interface, the task description is shown “Hi there, please write up SK words for our eBook based on research provided in Task #2, and the brief provided in the “Bundle brief’ section below. You have up to 3 days for this task. Thanks!. A second window cited the task value in dollars “450”. The category of the task “writing” is also shown, indicating the skill required to execute the task.

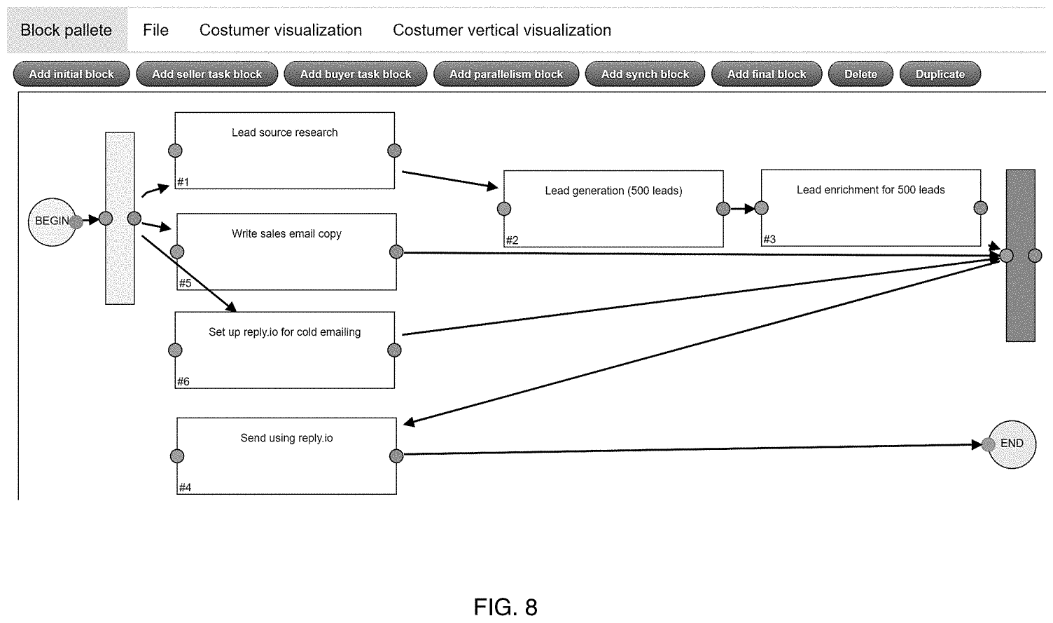

FIG. 8 is a further exemplary backend administrator interface configured to generate email marketing material, and furthermore generate leads to identify potential recipients.

It will be noted in these exemplary user interfaces the upper potion contains virtual buttons termed “add initial block”, “add seller task block”, “add buyer task block”, “add parallelism block”, “add synch block”, “add final block”, “delete” and “duplicate”. These buttons provide the means by which a user may introduce a task or other function onto the work space of the interface so as to construct a workflow. An arrow may be drawn (using a mouse) from one block to another to show the flow of task products throughout the workflow.

A “seller task block” defines a task for a third-party provider (such as a freelancer, equivalent to a task executor). A “buyer task block” defines a task (typically a reviewing task) to be carried out by a buyer (equivalent to a customer or a project originator).

A “parallelism block” is used for a task that may be carried out in parallel with one or more other tasks.

A “synch block” is used to ensure that a task executor does not commence a task directly dependent on two earlier tasks until both of the earlier tasks are completed and made accessible. An example is shown in the interface of FIG. 8, whereby task #2 is not commenced until both task #1 and task #5 are completed.

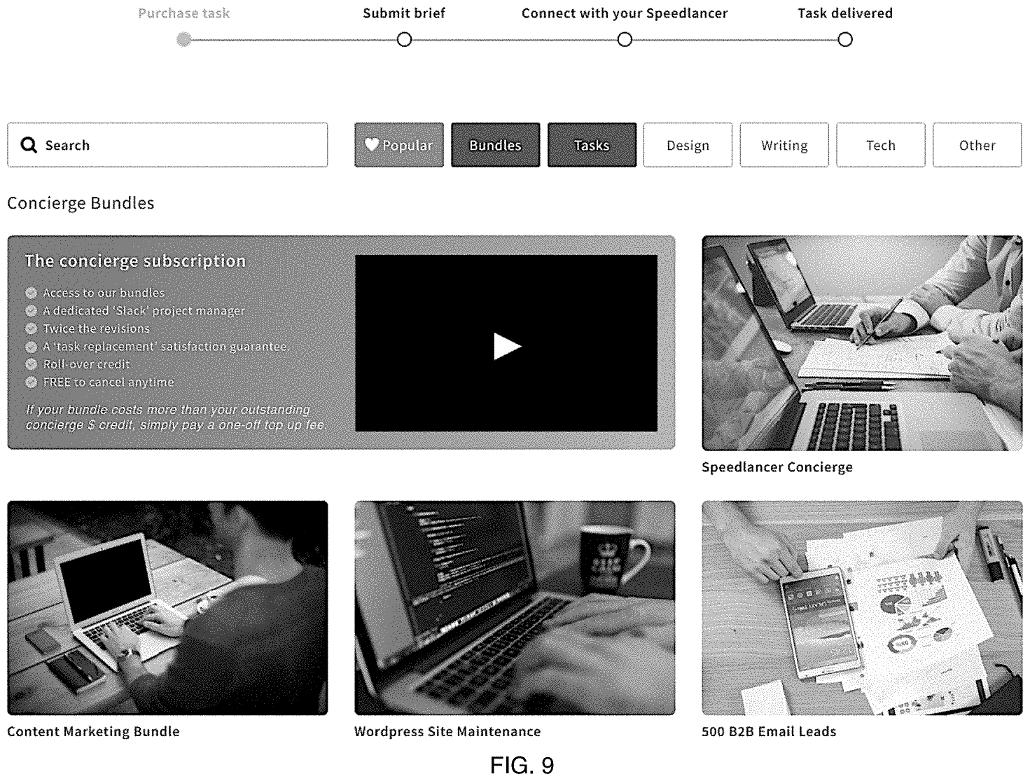

The project originator user interfaces provide a higher level of user experience than the backend administrator interfaces discussed above. Exemplary user interfaces are shown in FIG. 9 and onwards.

Referring firstly to FIG. 9, this screen shows an interface shown to a project originator (or “buyer”). After signing in, the buyer is presented with a selection of preset tasks, and “bundles” of tasks. In this example, a “branding bundle” is selected.

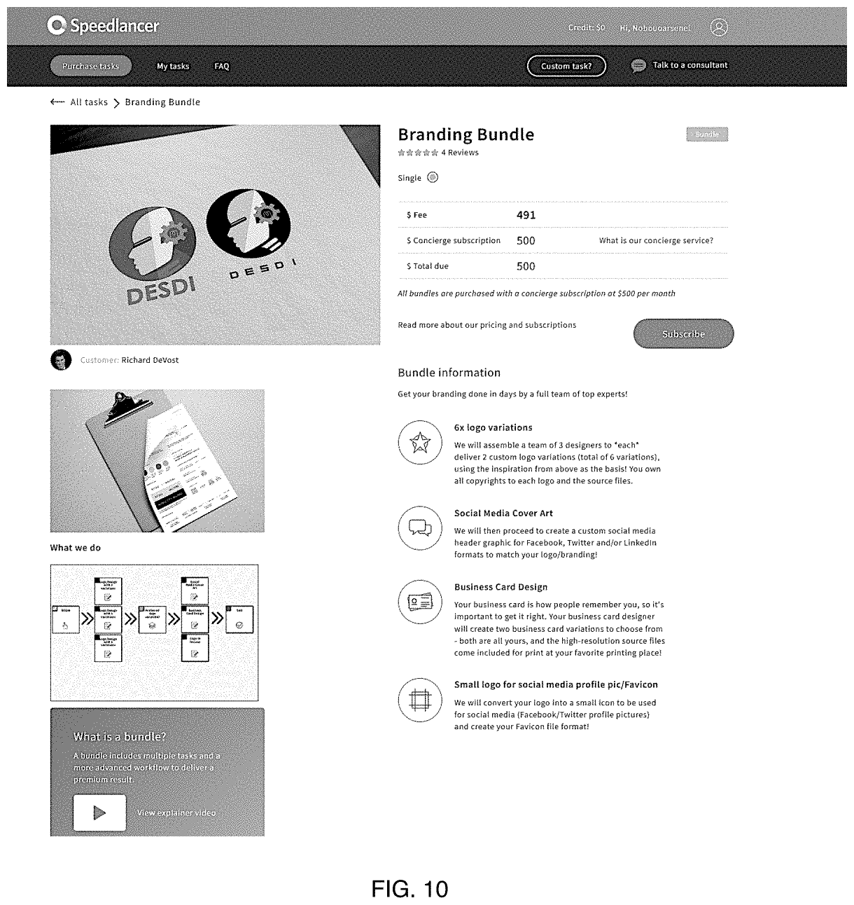

As shown in FIG. 10, the interface then allows the buyer to order the bundle by clicking on “Buy Now”—credit card or Pay Pal.

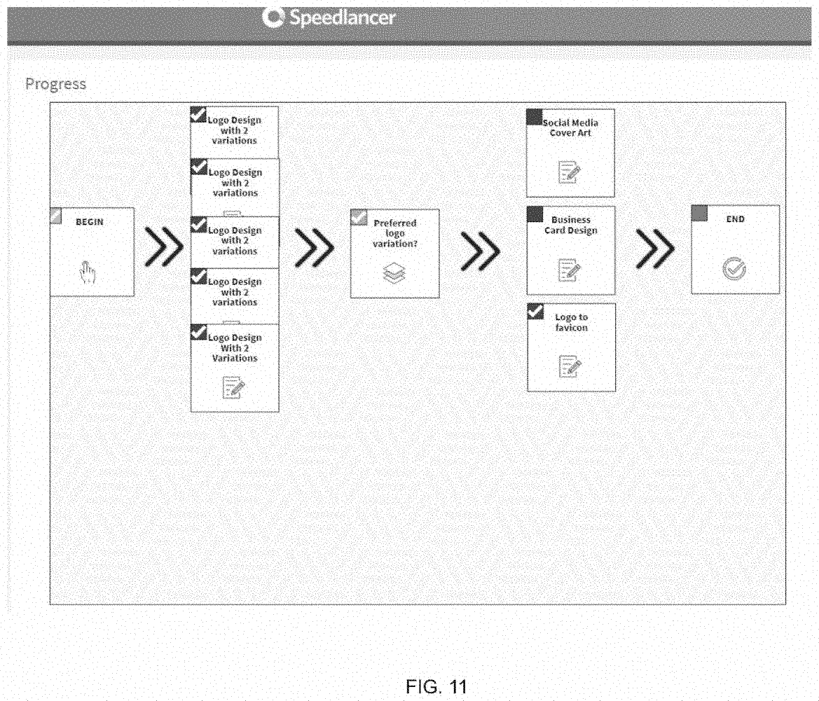

When purchase is confirmed, the interface of FIG. 11 is shown to the buyer, detailing the bundle (project) workflow.

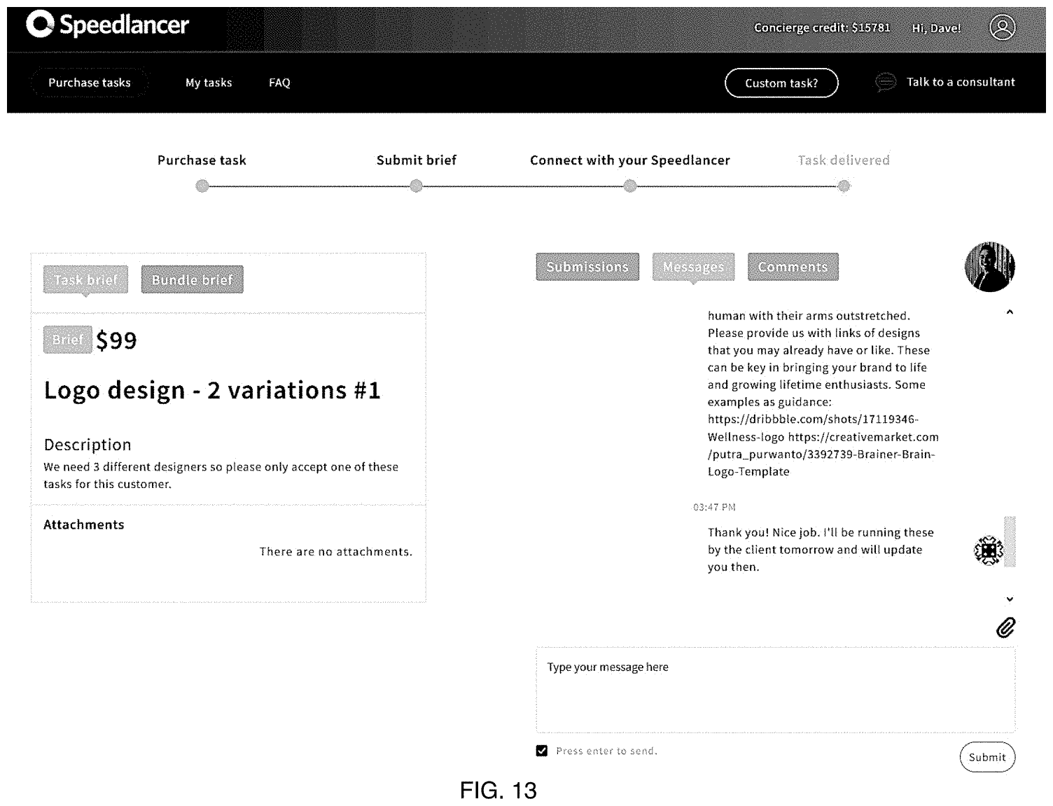

After a backend system administration reviews the bundle workflow, the first set of tasks is published. Task notification emails are sent out to the buyer, and also pre-registered task administrators (“sellers”) having suitable skills. An exemplary email is shown in FIG. 12. The system allows for buyers and sellers to communicate via a comments interface. An exemplary comments interface is shown at FIG. 13. Comments are public and may be read by other participants of the system. A seller can message a buyer before accepting a task by using Comments. After a seller accepts the task, comments are closed and messages are open which is visible to the assigned seller and the buyer.

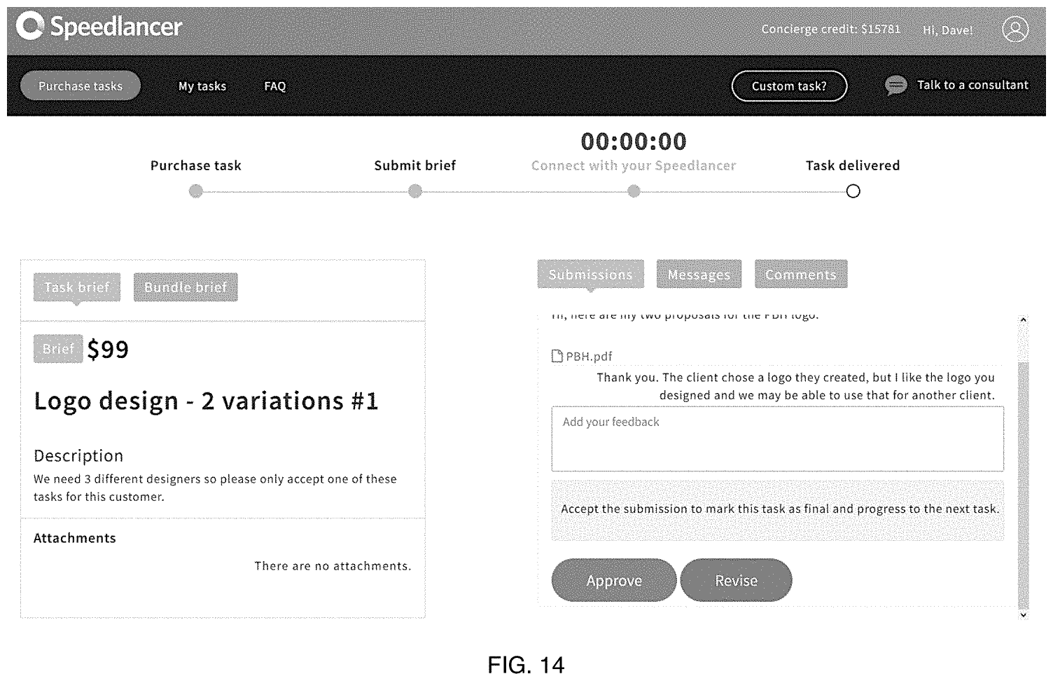

After a task product is delivered (i.e., made available to the buyer), the buyer may approve the task or send it back to the seller for revision if needed. An exemplary interface is shown at FIG. 14.

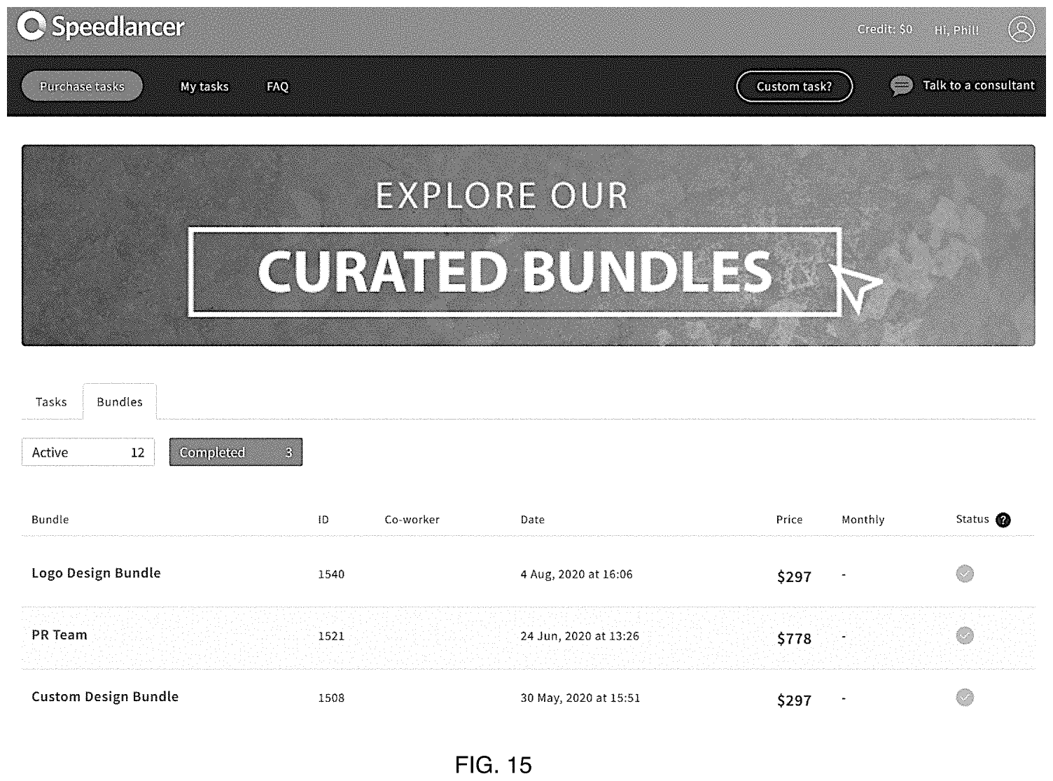

Some bundles have multiple variations for a given task, and the buyer user interface may present the option to select from the variations provided, as shown in the exemplary interface of FIG. 15.

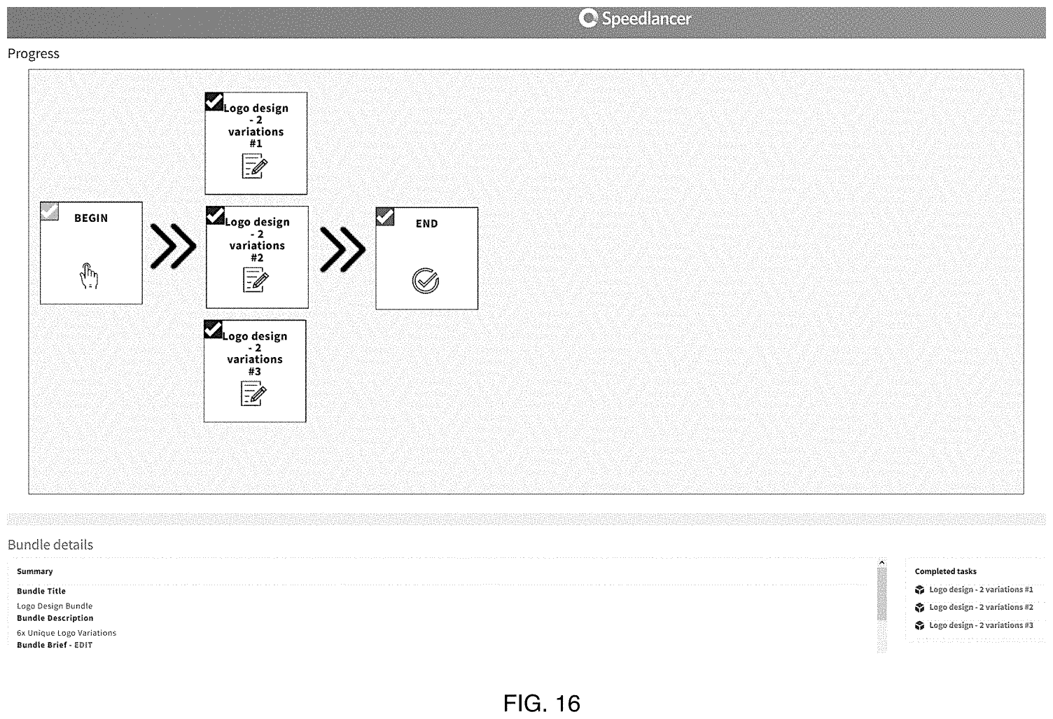

All tasks under a bundle are linked. The exemplary user interface of FIG. 16 shows how a present task is related to another task.

It should be understood that the present invention is capable of effectively assembling a project team automatically, in part or entirely, with each member of the team (task executors) having one or more skills required for the execution and completion of the entire project. In such cases, the system assembles the project team based on a definition of workflows or the definition of a workflow deliverable (such as the end product, product intermediate, or other outcome). A primary feature of the present invention is that it facilitates project execution automatically, or at least with a highly decreased input or action required by the project originator to maximize efficiency. An algorithm, informed by machine learning, is configured to decide, on behalf of the task originator, the ideal order in which tasks are to be completed. For example, the algorithm may decide that certain tasks should be configured for parallel execution based on the type of project. As previously described in the summary portion, an example of this in execution may be a workflow comprising a printing task (such as a business card). For such a workflow, the algorithm may default to making the actual printing the final task which is not commenced until all other tasks are completed (logo design, text placement and shape, approval, etc.), and some of these tasks may be configured for parallel execution, such as website design which would inherently later implement the logo of the business card. In workflows in which approval by a human is inherently required, the system is configured to automatically halt workflow (such as if multiple potential iterations of the logo are desired, one of which much be selected by the task originator prior to commencing subsequent tasks).

It should be noted that the central coordinating computer 100 may be understood to be a secured server computer disposed in communication with at least one database, and is configured to host the platform of the present invention to other computers in the system, including, but not limited to the project originator's computer and the task executors' computers.

While the invention has been disclosed in connection with the illustrative embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

The present invention has been disclosed particularly with reference to small business applications, and typically in reference to applications requiring the generation of graphics (such as logos) and text (such as research). Given the benefit of the present specification the skilled person will readily conceive of the many other applications. For example, the invention may be applicable to the generation of a prototype product whereby the tasks include product design, selection of materials, sourcing of materials, assembly of materials into a product, and product testing. Thus, some or all of the tasks may be performed away from a computer, and may be carried out manually. In such embodiments, the system operates to select suitable task executors and to schedule tasks according to any dependency or parallelism, send notifications and other communications between participants in the system, advise a project manager when a task is complete, instruct a task executor to commence work, allow for review of any task product by a project originator, and instruct revision or any task product.

1. A method for managing workflow for projects via computers comprising:
a secured server computer hosting a platform, the secured server computer disposed in communication with a database, the database containing a list of task executors suited to assorted tasks;
wherein task executors are freelancers;
a task originator logging into the platform from a task originator computer;
the task originator starting a new project on the platform, the project having at least one task with which it is associated;
the task originator's computer accepting input from the task originator as parameters of the at least one task associated with the project;
wherein parameters include a due date and time for the task and file format for task output where applicable;
the task originator assigning at least one category to the at least one task;
an algorithm of the platform analyzing the parameters and category;
the secured server computer parsing the database to find one or more optimally suited task executors based on the parameters of the at least one task as input by the task originator on the task originator's computer;
the algorithm employing machine learning to output ideal candidates for the at least one task from the database of task executors;
wherein ideal candidates are those with preferred ratings, indicated as presently available for new task assignment, and are experienced in the type of the at least one task as indicated by the at least one category assigned to the at least one task;
the database of the central coordinating computer presents on the user interface a number of candidates to the project originator, sorted by rating without necessitating manual input of desired input criteria/search parameters;
the algorithm automatically selecting an appropriate number of candidates as hired task executors;
the project originator instructing the hired task executors to begin work on the at least one task;
the hired task executors completing the at least one task and supplying output to the platform in accordance with the parameters established by the task originator;
the platform automatically issuing a follow-up questionnaire to the task originator to rate and review hired task executors on their output; and
the secured server computer reassessing the ratings of hired task executors by processing the follow-up questionnaire.

2. The method of claim 1, wherein ratings of each task executor are dynamic based on the rating the task executor has earned for prior work for the specific task that the project originator is requesting.

3. The method of claim 1, wherein the algorithm is configured to automatically allocate work to the highest-rated, most suitable task executors first and trigger recruiting workflows in the event of a shortage of high-quality candidates.

4. The method of claim 2, wherein the rating is compiled and assigned by the algorithm according to the following criteria:
a qualitative net promoter score determined when the project originator rates each task completed by the task executor on a scale from 1 to 5 via the questionnaire, a Communication score determined by sentiment analysis executed by the algorithm on communications which occurred between the task originator and the task executor, and a delivery time score determined by a comparison, performed by the algorithm on the secured server computer, between the elapsed time the task took to complete by the task executor and a due date of the task.

5. The method of claim 4, wherein the delivery time score is informed by the intelligence for deadline monitoring that follows up with task executors automatically for failing to deliver output of a task on-time.

6. The method of claim 5, further comprising: the algorithm, informed by machine learning, deciding, on behalf of the task originator, the optimal order in which tasks are to be completed.

7. The method of claim 6, further comprising: the secured server computer automatically lowering the net promoter score of the assigned task executor in the event of project originator dissatisfaction with the completed task so that the system would automatically be less likely to choose the task executor in the future for a similarly assigned task; and
the secured server computer automatically lowering the net promoter score of the assigned task executor in the event of untimely completion of tasks so that the system would automatically be less likely to choose the task executor in the future for a similarly assigned task.

8. The method of claim 7, further comprising: the secured server computer sending a reminder to the task executor one day before a due date for the at least one task; and
the secured server computer initiating a request to reevaluate the Net Promoter Score of the task executor every two days after task completion.

9. The method of claim 8, further comprising: the system evaluating the task executor on behalf of the project originator after completion of the at least one task by the hired task executor;
the algorithm employing machine learning to analyze communications between the task executor and the task originator to determine the efficacy and sentiment state of the contact established between the task executor and the task originator; and
the algorithm lowering the score of the task executor if high-stress communications are evident based on the communications analysis, making the task executor to be less likely to be selected as an ideal candidate for similar tasks in the future.

10. The method of claim 1, wherein the ideal task executor need not require approval by the project originator prior to commencing work on the assigned task.

11. The method of claim 9, further comprising: the algorithm determining which of the ideal candidates are presently available for assignment of at least one task by querying most likely communication vectors of the candidates for recent activity and presence.
